(19) United States
(12) Patent Application Publication
(10) Pub. No.: US 2015/0149271 A1
(43) Pub. Date: May 28, 2015

(54) SYSTEM AND METHOD OF REDEEMING LOYALTY POINTS AT A POINT OF SALE

(71) Applicant: AMERICAN EXPRESS TRAVEL RELATED SERVICES COMPANY, INC., New York, NY (US)

(72) Inventors: CHARLES BATTLE, Brooklyn, NY (US); NAGESHWARA CHIRRAVURI, Chandler, AZ (US); COLLEEN DECHON, Brooklyn, NY (US); PRIYADARSHINI KOUL, Scottsdale, AZ (US); SATHISH MUTHUKRISHNAN, Phoenix, AZ (US); PHILIP NORMAN, Brooklyn, NY (US); VARUN SOOD, Phoenix, AZ (US); ELIZABETH VAKIL, New York, NY (US); DAVID WOLF, Brooklyn, NY (US)

(73) Assignee: AMERICAN EXPRESS TRAVEL RELATED SERVICES COMPANY, INC., New York, NY (US)

(21) Appl. No.: 14/188,415

(22) Filed: Feb. 24, 2014

Related U.S. Application Data
(60) Provisional application No. 61/909,204, filed on Nov. 26, 2013.

(51) Int. Cl. G06Q 30/02; G06Q 20/38

(52) U.S. Cl. CPC G06Q 30/0233; G06Q 20/387; G06Q 30/0238
USPC 705/14.33

(57) ABSTRACT

The systems and methods for redemption of loyalty points to satisfy a transaction are provided. The systems and methods may include APIs that are capable of determining a balance of loyalty points in response to initiation of a payment transaction at the POS. The system may also include APIs that are configured to authorize the transaction. In this regard, the APIs may initiate their requests such that, the results of the requests (e.g., the loyalty point balance and the authorization) are received at substantially the same time.

### CROSS REFERENCE TO RELATED APPLICATIONS

This application claims priority to U.S. Provisional Ser. No. 61/909,204, filed Nov. 26, 2013, which is hereby incorporated by reference in its entirety for all purposes.

### FIELD

The present disclosure relates to systems and methods for loyalty point redemption, and more specifically, redemption of loyalty points via a point of sale device.

### SUMMARY

In various embodiments, payment and/or redemption of points to satisfy a transaction may be accomplished by various systems and methods as described herein including those systems and methods described in the Appendix included herewith.

A method for paying with points at a POS is provided. The method may be performed by a computer based system for managing a reward account. In various embodiments, the computer based system may be configured to receive a request for an eligibility determination, in response to a transaction account being presented at a POS. A request for an authorization of a transaction amount in a transaction account may be also be transmitted, such that the result of the request for the eligibility determination and the result of the request for the authorization are received at substantially the same time. The computer based system may be configured to determine an eligibility status associated with the transaction account. The computer based system may also be configured to create instructions to allow a user to elect to pay with points.

In various embodiments, the eligibility status may be based on at least one of a reward account balance and a preference associated with at least one of the transaction account and the rewards account.

In various embodiments, an authorization may be created based on the transaction account being presented at the POS. The authorization may include a credit hold on the transaction account. The credit hold may be reversed in response to receiving an election to pay with points at the POS.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates a system diagram of an exemplary pay with points system, in accordance with various embodiments;

FIGS. 2A-2E illustrate various exemplary point of sale terminal screens included in a pay with points system, in accordance with various embodiments;

FIG. 2F illustrates an exemplary receipt showing a transaction processed using a pay with points system, in accordance with various embodiments; and

FIGS. 3A-3B illustrate exemplary process flows for a pay with points transaction in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, a pay with points program may allow a user to redeem reward points as payment. The pay with points program may be associated with a transaction account. In this regard, the program may be accessible at a point of sale (“POS”) based on and/or in response to a presentation of the transaction account at the POS. For example, a user may provide, present, swipe, and/or tap a transaction account (e.g., a credit and/or charge card) at a POS to initiate and/or authorize a transaction (“transaction initiation”). The initiation and/or request for authorization of a transaction may trigger and/or activate a pay with points program.

In various embodiments and in operation, the program may leverage one or more application programming interfaces (“API”). For example, the program may leverage a first API that is configured to determine transaction account eligibility to pay with points. The POS system may also be configured to simultaneously and/or at substantially the same time seek authorization for payment with a transaction account. The program may also leverage a second API that is configured to query a rewards program. In this regard, the second API may be capable of determining an amount of rewards points in a user's account, the status of the account, the amount of points needed to satisfy transaction and/or the like. Moreover, these one or more APIs may be accessible by a user and/or activated by a user input through the POS.

In various embodiments, by providing one or more APIs at the POS, a user may be capable of satisfying a transaction with reward points regardless of how the user initially intended to pay for the transaction. For example, a user may initiate a transaction by presenting a transaction account at the POS. That transaction initiation may cause the pay with points POS, via traditional transaction processing methods, to initiate an authorization via a payment processor and with a transaction account issuer. This transaction initiation may also cause the second API to query a rewards program and/or rewards program administrator (e.g., the American Express Membership Rewards® Program). In response to a rewards program being eligible for payment at the POS, the API may determine a balance of rewards points and an amount of rewards points needed to satisfy a transaction. This balance may be determined by any suitable method including, for example, by applying a conversion ratio to the points to determine a dollar amount for a prescribed number of points. In response to the program being eligible and the account having a sufficient number of points to satisfy at least a portion of the transaction, the API may trigger the POS to display and/or request from a user whether the user would like to pay with points.

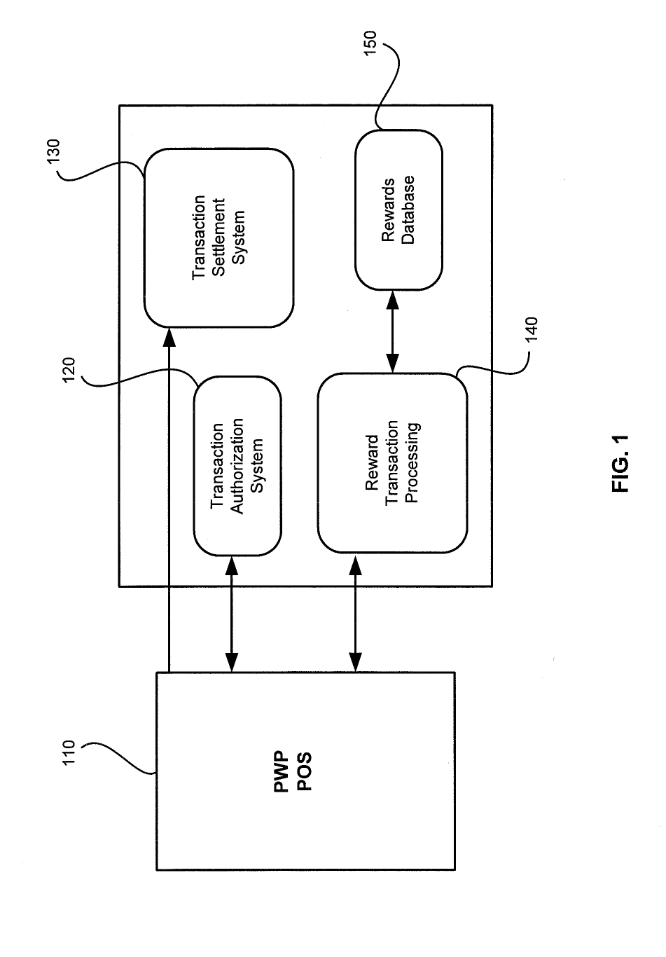

In various embodiments, with reference to FIG. 1, pay of points system 100 may comprise a pay with points POS 110, a transaction authorization system 120, a transaction settlement system 130, a rewards transaction processing module 140, and a rewards database 150.

In various embodiments, each of the transaction authorization system 120 and reward transaction processing module 140 may be accessible by the user through the pay with points POS 110 via one or more APIs. Pay with points POS 110 may be any suitable POS terminal configured with a first API that is capable of determining transaction account eligibility. Pay with points POS 110 may also be capable of initiating a transaction with a transaction account. For example, pay with points POS 110 may be a physical POS that is capable of initiating a transaction with a traditional charge and/or credit card. In this regard, pay with points POS 110 may be a physical POS at an item provider, retail location, and/or the like. Pay with points POS 110 may also be configured with a second API that is capable of initiating a transaction to redeem loyalty and/or reward points. Pay with points POS 110 may be a traditional swipe style POS. Pay with points POS 110 may also be configured with a tap style and/or contactless payment module. In this regard, a smart card may be presented to the contactless payment module to initiate a transaction.

In various embodiments, transaction authorization system 120 may be any suitable transaction authorization system configured to initiate and/or authorize a typical credit or charge based transaction (e.g., a credit card transaction). Transaction settlement system 130 may be any suitable transaction settlement system configured to settle the typical credit or charge based transaction. In this regard, transaction authorization system 120 and transaction settlement system 130 may be in electronic communication and/or configured to initiate and settle a transaction against a transaction account of the user. That transaction may originate based on an action from the user at pay with points POS terminal 110.

In various embodiments, reward transaction processing module 140 may be any suitable reward transaction processing module configured to initiate a reward point transaction and/or redemption. In this regard, reward transaction processing module 140 may be in electronic communication and/or configured to receive commands from second API installed on or configured to operate between pay with points POS 110 and reward transaction processing module 140. Rewards database 150 may be in electronic communication with reward transaction processing module 140. Rewards database 150 may comprise reward account information including, for example, reward account numbers, reward account balances, look up tables, data associating transaction accounts with reward accounts, conversion tables, and/or the like.

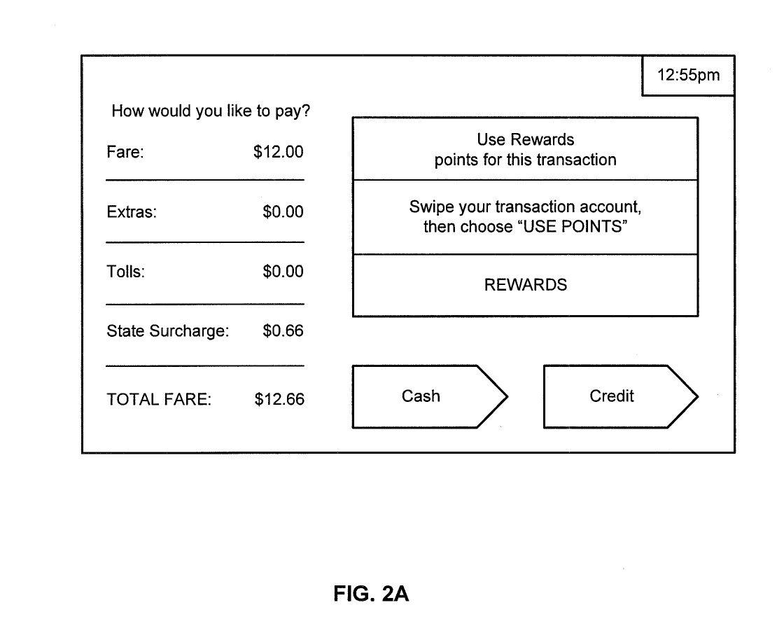

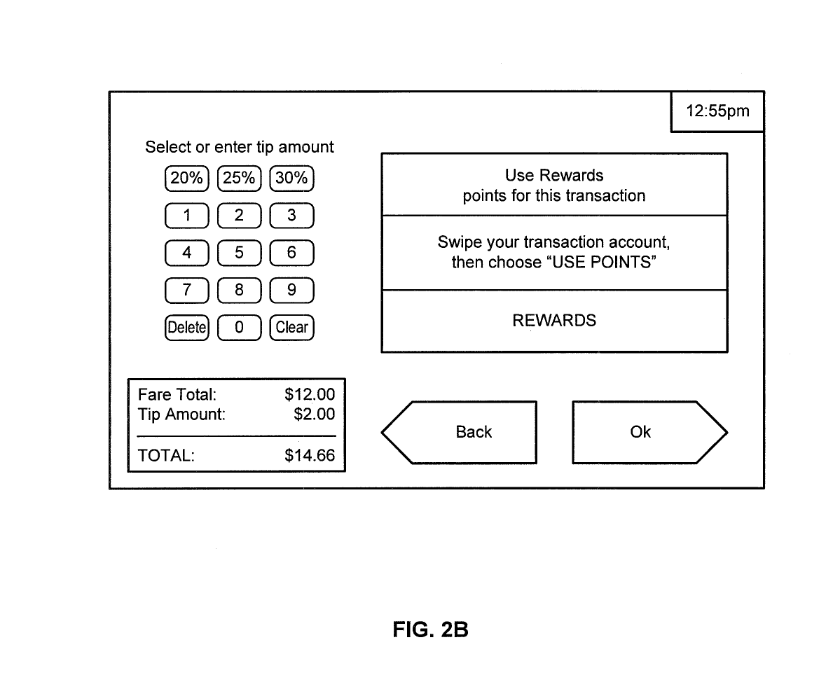

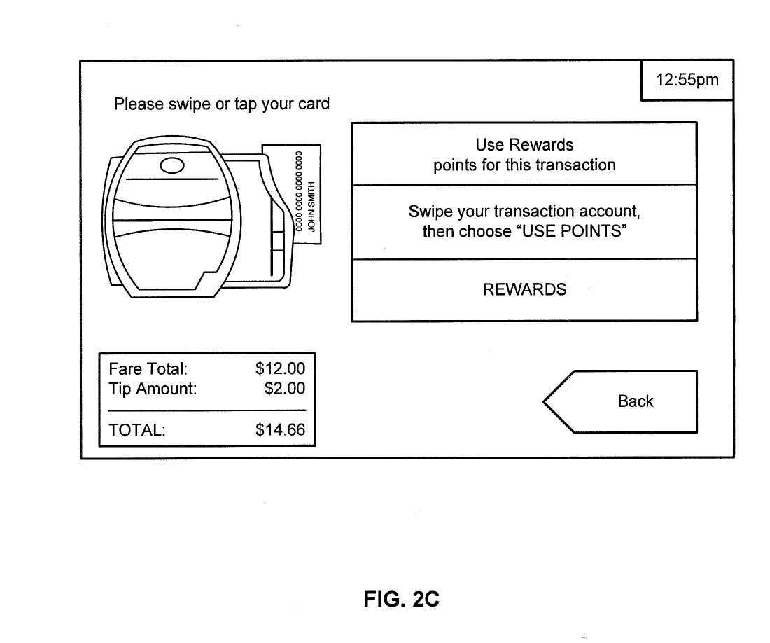

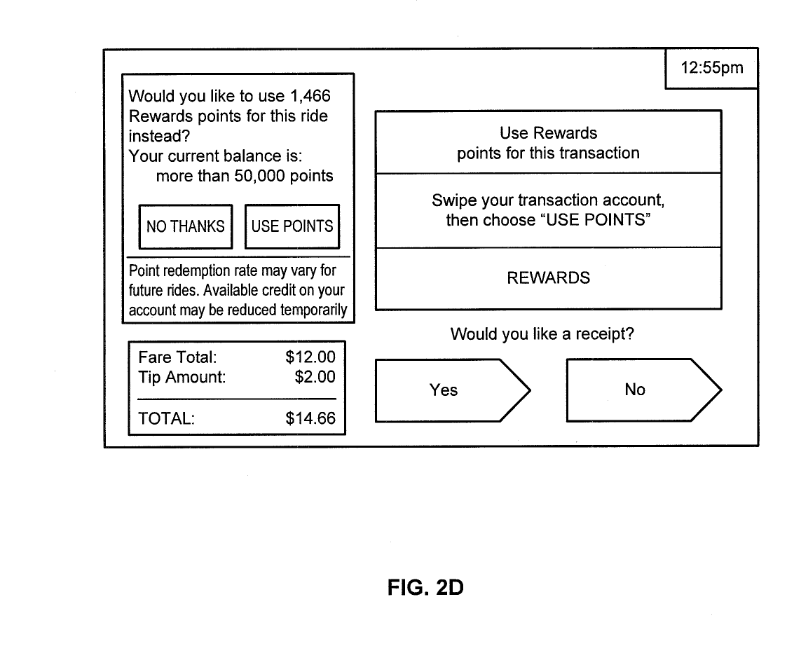

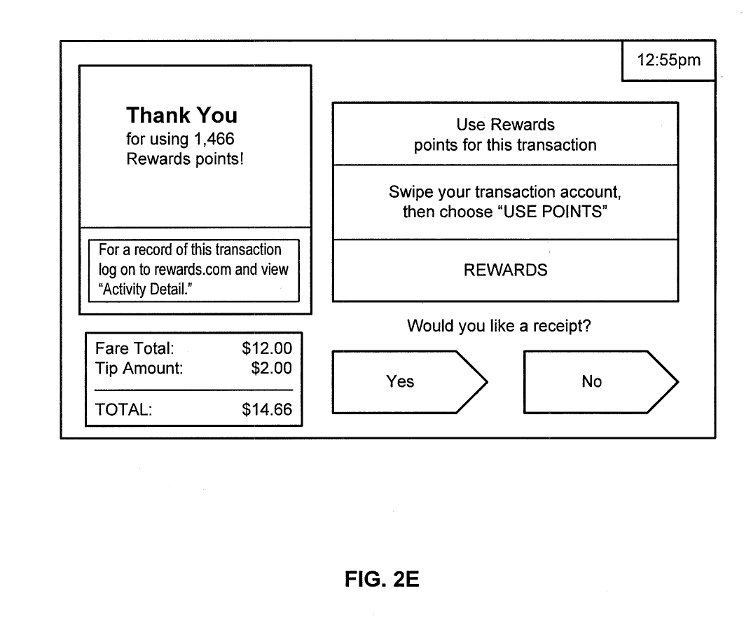

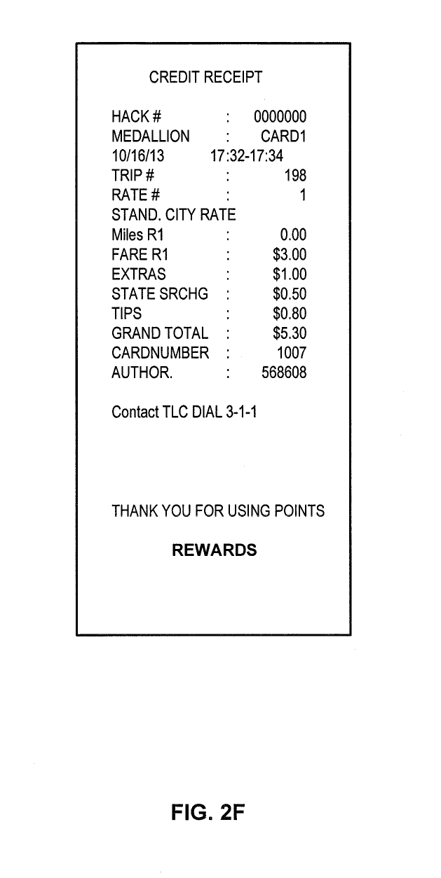

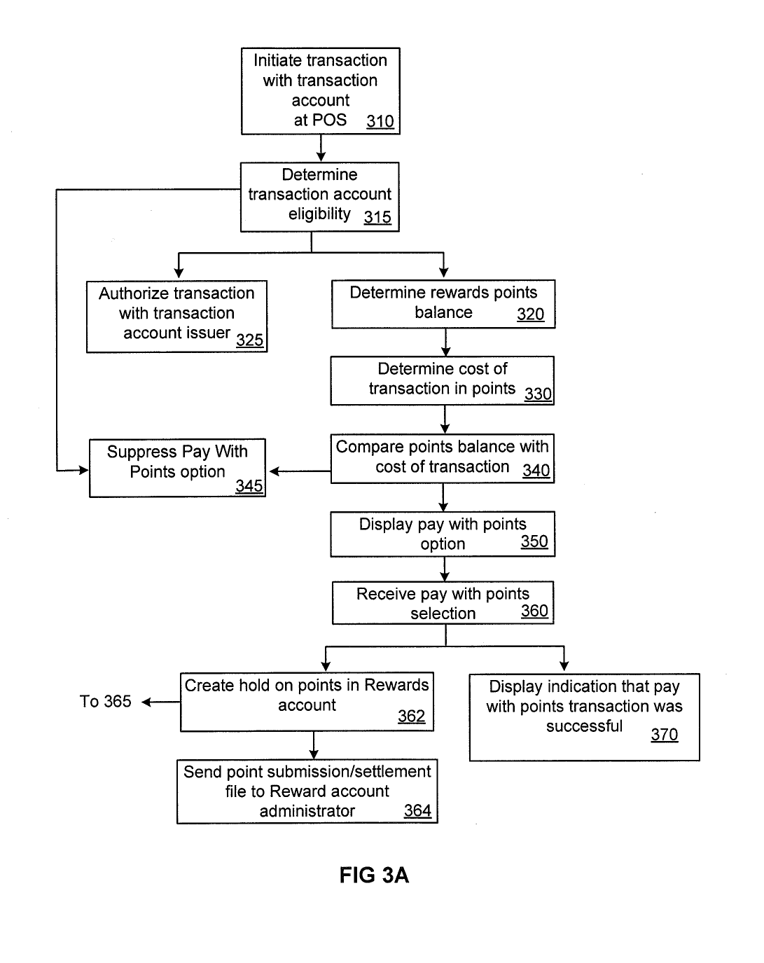

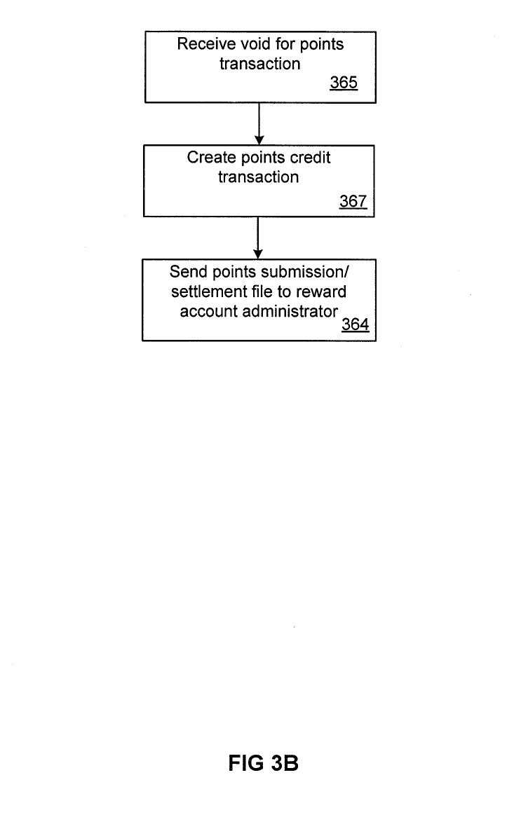

In various embodiments and with reference to FIGS. 1, 2A-2E and 3A-3B, in operation, pay with points POS 110 may be configured to display a settlement screen upon services being rendered or goods being processed for purchase, as shown in FIG. 2A. The settlement screen may comprise an itemized lists of charges, payment options (e.g., cash or credit), and/or the like.

In various embodiments and in response to selecting a payment option (e.g., credit) at pay with points POS 110, the display may change and allow a user to make further settlement selections, as shown in FIG. 2B. For example, pay with points POS 110 may allow a user to adjust a transaction amount (e.g., to include a tip, or cancel the purchase of an item). In response to the settlement selections being made (e.g., the user selects a tip amount and the “OK” button), pay with point POS 110 may instruct the user to initiate a transaction with a transaction account at pay with points POS 110 (Step 310) (e.g., present a transaction account, swipe a transaction card, tap a smart card, and/or the like), as shown in FIG. 2C.

In various embodiments, pay with points POS 110 may send a request in response to the initiation of a transaction to transaction authorization system 120 and/or rewards transaction processing system 140. Based on the request, transaction authorization system 120 and/or rewards transaction processing system 140 may determine transaction account eligibility for a pay with points transaction (Step 315), via the first API. In response to the transaction account being not eligible for a pay with points transaction, pay with points POS 110 may be capable of suppressing or limiting the pay with points option (Step 345).

In various embodiments, and in response to a transaction being initiated at pay with points POS 110, the pay with points POS 110 may contact transaction authorization system 120 to authorize a transaction account with a transaction account issuer (e.g., authorization of a credit card) (Step 325). At substantially the same time, a second API may initiate and/or may call reward transaction processing module 140. As used herein, “substantially the same time” or “concurrently” may include simultaneously, within seconds, within minutes and/or in response to the results from the first API and the second API being returned to the pay with points POS 110. In this regard, substantially the same time may be perceived by a user as “real time” such that there is not a substantial delay at pay with points POS 110 to select a pay with points option and/or otherwise complete the transaction.

In response to this call and/or initiation from the second API, reward transaction processing module 140 may query reward database 150. This query may include a determination of eligibility (e.g., Step 315). The determination of eligibility may be based on one or more factors including for example, transaction account type, reward account type, reward account balance, account standing and/or the like. In response to the transaction account being eligible, reward transaction processing module 140 may determine a reward point balance (Step 320). Reward transaction processing module 140 may also determine the cost of the transaction in points (Step 330). For example, reward transaction processing module 140 may use a conversion ratio, points value, transaction account status, transaction amount, business rules, reward account balance, and/or the like to determine the cost of the transaction in points.

In various embodiments, reward transaction processing module 140 may compare the points balance to the cost of the transaction (Step 340). In response to the points balance being insufficient to cover the cost of the transaction and/or a portion of the transaction, reward transaction processing module 140 and/or pay with points POS 110 may suppress or restrict the pay with points option. In various embodiments, reward transaction processing module 140 may be configured to facilitate partial satisfaction of a transaction with points. The partial satisfaction may be governed by a set of rules, including for example, partial satisfaction of a minimum percentage (e.g., thirty (30) percent of a transaction must be satisfied with points), partial satisfaction of a transaction of a minimum amount (e.g., the transaction amount must be at least $40), and/or the like. Reward transaction processing module 140 and/or pay with points POS 110 may, via the second API, cause to pay with points POS 110 to display the option to satisfy the transaction with reward points, as shown in FIG. 2D (Step 350).

In various embodiments, pay with points POS 110, the second API and/or a reward transaction processing module 140 may present the option to use and/or redeem points at pay with points POS 110. Pay with points POS 110 may be configured to receive a selection from a user to use points to satisfy the transaction (Step 360). The display of the use points option may also include a point amount to satisfy the transaction and a current point balance to provide the user with some account information about how the transactions may impact the reward point account balance.

In various embodiments and in response to receiving a pay with points selection, pay with points POS 110 and/or reward transaction processing module 140 may, via a rewards API, create a hold on points in the reward account (Step 362). Such a hold may reserve and/or otherwise make unavailable a number of points that correspond to the cost of the transaction in points and/or a portion of the cost of the transaction in points. The unavailable and/or held points may be removed and/or debited from the account in response to a submission and/or settlement file be sent and/or provided to a reward account administrator and/or reward transaction processing module 140.

In various embodiments and in response to the hold being created and/or the points being made unavailable, pay with points POS 110 may be configured to display that the pay with points transaction was successful (Step 370). Pay with points POS 110 may initiate a reversal of the authorization obtained by the first API via transaction authorization system 120 and/or transaction settlement system 130. In this regard, the hold that was initially created on the transaction account (e.g., the hold against the available line of credit) may be reversed. The pay with points program may also provide an indication that the transaction has been settlement with points. For example, pay with points POS 110 may display a settlement screen indicating that the transaction was at least partially satisfied using points, as shown in FIG. 2E. Pay with points POS 110 may also be configured to provide a receipt of the transaction, as shown in FIG. 2F.

In various embodiments, pay with points POS 110 and/or reward transaction processing module 140 may be configured to reverse and/or cancel a point hold in response to receiving a void for the points transaction (Step 365). In this regard, pay with points POS 110 and/or reward transaction processing module 140 may create a points credit transaction (Step 367). The points credit transaction may be equal to the points made unavailable. The points credit transaction may be included in the submission and/or settlement file such that the initial points hold and/or associated points debit is off-set and/or canceled by the points credit transaction. In this regard, the points unavailable may be made available and/or be re-credited to the rewards account in response to the points submission and/or settlement file being sent to the reward account administrator (Step 364).

In various embodiments, the pay with points program may be accessible to a user of any transaction account. The pay with points program may require that a user register in order to participate in the program. Moreover, the registration may include election about how and/or when the option to pay with points at a POS is available. Alternatively, the pay with points program may require no registration and may be available to any user having a transaction account and rewards account, and/or a combined transaction and rewards account, where rewards points are associated with the transaction account.

In various embodiments, a user may opt out of using and/or having access to the pay with points program. This opt out may be available to the user at the POS or by making a selection associated with the user's transaction account (e.g., by calling customer service or making a selection through a transaction account profile).

In various embodiments, the pay with points program may be suppressed in response to a user having an insufficient number of points to cover the total amount of the transaction. Alternatively, the pay with points program may be configured to provide payment partial for a partial transaction amount.

In various embodiments, conversion rate of points to transaction amount may be any suitable conversion rate established by a reward point issuer and/or a transaction account issuer.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, an transaction account user, an account affiliate, a child account user, a subsidiary account user, a beneficiary of an account, a custodian of an account, and/or any other person or entity affiliated or associated with a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

In various embodiments, an account number may identify a consumer. In addition, in various embodiments, a consumer may be identified by a variety of identifiers, including, for example, an email address, a telephone number, a cookie id, a radio frequency identifier (“RFID”), a biometric, and the like.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows operating system, UNIX®, Linux®, Solaris®, MacOS, etc.) as well as various conventional support software and drivers typically associated with computers.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer®, Mozilla Firefox®, Google® Chrome, Apple® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

In various embodiments, components, modules, and/or engines of systems may be implemented as micro-applications or micro-apps. Micro-apps are typically deployed in the context of a mobile operating system, including for example, a Palm® mobile operating system, a Windows® mobile operating system, an Android® Operating System, Apple® iOS, a Blackberry® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, data, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software,. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank.

In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a computer based system for managing a reward account, a request for an eligibility determination in response to a transaction account being presented at a POS, wherein a request for an authorization of a transaction amount in a transaction account is transmitted to the computer based system such that the result of request for the eligibility determination and the result of the request for authorization are received at substantially the same time;
determining, by the computer based system, an eligibility status associated with the transaction account; and
providing, by the computer based system, instructions to allow a user to elect to pay with points.

2. The method of claim 1, wherein the transaction account is associated with a reward account.

3. The method of claim 2, wherein the eligibility status is based on at least one of a reward account balance and a preference associated with at least one of the transaction account and the rewards account.

4. The method of claim 1, wherein the POS is a physical POS.

5. The method of claim 1, wherein an authorization is created based on the transaction account being presented at the POS.

6. The method of claim 5, wherein the authorization includes a credit hold on the transaction account.

7. The method of claim 6, wherein the credit hold is reversed in response to receiving an election to pay with points at the POS.

8. The method of claim 1, further comprising determining a number of points required to satisfy the transaction.

9. The method of claim 8, further comprising receiving, by the computer based system and via the POS, an selection to satisfy at least a portion of the transaction with points.

10. The method of claim 9, wherein a points transaction is created in response to the transaction and the selection satisfying a business rule.

11. The method of claim 1, wherein the option to pay with points is displayed via the POS in response to receiving the instructions from the computer based system.

12. The method of claim 11, wherein the option to pay with points is suppressed in response to not receiving a selection at the POS in a predetermined period of time.

13. The method of claim 1, further comprising creating, by the computer based system, a points hold for a rewards account in response to receiving a selection to pay with points via the POS.

14. The method of claim 13, wherein points held by the points hold are debited form the rewards account in response to receiving a settlement file.

15. An article of manufacture including a non-transitory, tangible computer readable storage medium having instructions stored thereon that, in response to execution by a computer-based system for managing a reward account, cause the computer-based system to perform operations comprising:
receiving, by the computer based system, a request for an eligibility determination in response to a transaction account being presented at a POS, wherein a request for an authorization of a transaction amount in a transaction account is transmitted to the computer based system such that the result of the request for the eligibility determination and the result of the request for authorization are received at substantially the same time;
determining, by the computer based system, an eligibility status associated with the transaction account; and
creating, by the computer based system, instructions to allow a user to elect to pay with points.

16. The apparatus of claim 15, wherein the POS is a physical POS.

17. The apparatus of claim 15, wherein the option to pay with points is displayed via the POS in response to receiving the instructions from the computer based system.

18. A system comprising:
a processor for managing a rewards account, and
a tangible, non-transitory memory configured to communicate with the processor, the tangible, non-transitory memory having instructions stored thereon that, in response to execution by the processor, cause the processor to perform operations comprising:
receiving, by the processor, a request for an eligibility determination in response to a transaction account being presented at a POS, wherein a request for an authorization of a transaction amount in a transaction account is transmitted to the computer based system such that the result of the request for the eligibility determination and the result of the request for authorization are received at substantially the same time;
determining, by the processor, an eligibility status associated with the transaction account; and
creating, by the processor, instructions to allow a user to elect to pay with points.

19. The system of claim 18, wherein the POS is a physical POS.

20. The system of claim 18, wherein the option to pay with points is displayed via the POS in response to receiving the instructions from the processor.
